(19) United States
(12) Patent Application Publication
(10) Pub. No.: US 2019/0180294 A1
(43) Pub. Date: Jun. 13, 2019

(54) SUPPLIER CONSOLIDATION BASED ON ACQUISITION METRICS

(71) Applicant: Coupa Software Incorporated, San Mateo, CA (US)

(72) Inventors: Justin Mehta, Belmont, CA (US); Andrew Miller, San Mateo, CA (US)

(21) Appl. No.: 15/840,936

(22) Filed: Dec. 13, 2017

(51) Int. Cl. G06Q 30/02

(52) U.S. Cl. CPC G06Q 30/0201; G06Q 10/0637; G06Q 30/0239

(57) ABSTRACT

Techniques are provided for supplier consolidation based on acquisition metrics. In an embodiment, supplier economic data is determined for multiple suppliers based at least in part on data regarding acquisitions from the multiple suppliers. A request is received for a recipient supplier consolidation and aggregated recipient economic data is determined based on an acquisition history of the recipient, the aggregated recipient economic data corresponding to acquisitions of one or more acquisition items for the recipient. An improvement set of suppliers is determined from the multiple suppliers based on the supplier economic data for the multiple suppliers and the aggregated recipient economic data for the one or more acquisition items. The received request for recipient supplier consolidation is responded to with the improvement set of suppliers.

### FIELD OF THE DISCLOSURE

The present disclosure is generally related to data analysis acquisitions, and more particularly to provider consolidation based on acquisition metrics.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

The requisitions of services and supplies for a company can be complex and opaque. A company may have numerous subsidiaries, and each subsidiary may have multiple locations where the company operates. Each subsidiary may acquire services (e.g., information technology support) and supplies (e.g., office equipment or office supplies) from numerous suppliers, often without knowledge that the other locations or subsidiaries are purchasing similar services and supplies from the same or different suppliers. Bringing this information into a single, coherent form is difficult, and is rarely achieved by companies.

Many suppliers and service providers have economies of scale and provide discounts when buyers purchase or commit to purchase at certain levels of spend. Because the companies are not able to determine whether they are using the same suppliers and service providers for the same or similar services, they cannot obtain the benefits of scale or discounts that might be provided to them.

Based on the foregoing, there is a need to synthesize vast amounts of transaction data in order to obtain the benefits of scale and discounts. The techniques described herein address these issues.

### BRIEF DESCRIPTION OF THE DRAWINGS

In the drawings:

FIG. 1 illustrates an example networked computer system in which various embodiments may be practiced.

FIG. 2 illustrates an entity diagram depicting a business entity and associated subsidiaries.

FIG. 3 illustrates an example algorithm or method consolidating suppliers based on acquisition metrics, according to various embodiments.

FIG. 4 illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described in sections according to the following outline:

1.0 GENERAL OVERVIEW

2.0 EXAMPLE NETWORKED COMPUTER SYSTEM

3.0 EXAMPLE ALGORITHMS AND METHODS

4.0 HARDWARE OVERVIEW

5.0 OTHER ASPECTS OF DISCLOSURE

1.0 General Overview

In various embodiments, methods and computer systems are provided that are programmed or configured to automatically consolidate suppliers based on acquisition metrics. In an embodiment, supplier economic data is determined for multiple suppliers based at least in part on data regarding acquisitions from the multiple suppliers. A request is received for a recipient supplier consolidation and aggregated recipient economic data is determined based on an acquisition history of the recipient, the aggregated recipient economic data corresponding to acquisitions of one or more acquisition items for the recipient. An improvement set of suppliers is determined from the multiple suppliers based on the supplier economic data for the multiple suppliers and the aggregated recipient economic data for the one or more acquisition items. The received request for recipient supplier consolidation is responded to with the improvement set of suppliers.

In an embodiment, a data processing method is executed using an e-procurement computer system and comprises the computer-implemented steps of determining supplier economic data for multiple different suppliers of goods or services, based at least in part on data describing prior transactions for acquisitions from the multiple suppliers; receiving a digital electronic message comprising a request for a supplier consolidation in association with a recipient; determining aggregated recipient economic data based on an acquisition history of the recipient involving a plurality of transactions, the aggregated recipient economic data corresponding to a plurality of acquisitions of one or more acquisition items for the recipient; determining an improvement set of suppliers from the multiple suppliers based on the supplier economic data for the multiple suppliers and the aggregated recipient economic data for the one or more acquisition items; responding to the request by electronically transmitting the improvement set of suppliers; wherein the method is performed using one or more computing devices.

In one feature, determining supplier economic data includes categorizing transaction data based on one or more items associated with past acquisitions of goods or services from the multiple suppliers; determining supplier discount thresholds based on the categorized transaction data and comparison of previous transactions between recipients and suppliers. In another feature, the supplier economic data comprises supplier discount threshold values associated with different discounts that are available in one or more spend categories. In still another feature, the aggregated recipient economic data indicates total spend for the recipient and one or more related recipients, over a period, for a plurality of different spend categories. In yet another feature, determining aggregated recipient economic data includes categorizing transactions included in the acquisition history of the recipient and aggregating the categorized transactions into aggregated recipient economic data. In a further feature, categorizing transactions included in the acquisition history of the recipient includes categorizing transactions associated with the recipient and categorizing transactions associated with recipients that are related to the recipient.

In another feature, aggregating the categorized transactions into aggregated recipient economic data includes aggregating spend associated with transactions by the recipient and spend associated with transactions by recipients that are related to the recipient. In yet another feature, the improvement set of suppliers indicates one or more suppliers that are capable of providing a spend discount to a recipient. In a further feature, determining the improvement set of suppliers includes determining the improvement set of suppliers based on delivery locations of the suppliers, community ratings of the suppliers, and health scores of the suppliers. In some embodiments, the method further comprises, in response to determining that a total spend for a spend category of a recipient and related recipients is within a threshold amount of a discount threshold, generating and causing displaying, at a computer associated with the recipient, a notification indicating that the total spend for a spend category is within a threshold amount of a supplier discount threshold.

In another feature, the method further comprises, in response to determining that a threshold amount of acquisitions by a buyer fall within a spend category, identifying the spend category as a critical spend category; determining a minimum number of suppliers in the improvement set based on identifying a critical spend category.

In another embodiment, a data processing method comprises determining supplier economic data for multiple suppliers, including: categorizing transaction data based on one or more items associated with acquisitions from multiple suppliers; determining supplier discount thresholds based on the categorized transaction data and comparison of previous transactions between recipients and suppliers; receiving a request for a recipient supplier consolidation; determining aggregated recipient economic data based on an acquisition history of the recipient, including: categorizing transactions included in the acquisition history of the recipient and aggregating the categorized transactions into aggregated recipient economic data, including categorizing transactions associated with the recipient, categorizing transactions associated with recipients that are related to the recipient, and aggregating spend associated with transactions by the recipient and spend associated with transactions by the recipients that are related to the recipient; determining an improvement set of suppliers from the multiple suppliers based on the supplier economic data for the multiple suppliers, the aggregated recipient economic data for the one or more acquisition items, delivery locations of the multiple suppliers, community ratings of the multiple suppliers, and health scores of the multiple suppliers; wherein the improvement set of suppliers indicates one or more suppliers that are capable of providing a spend discount to a recipient; responding to the received request for recipient supplier consolidation with the improvement set of suppliers; wherein the method is performed using one or more computing devices.

2.0 Example Networked Computer System

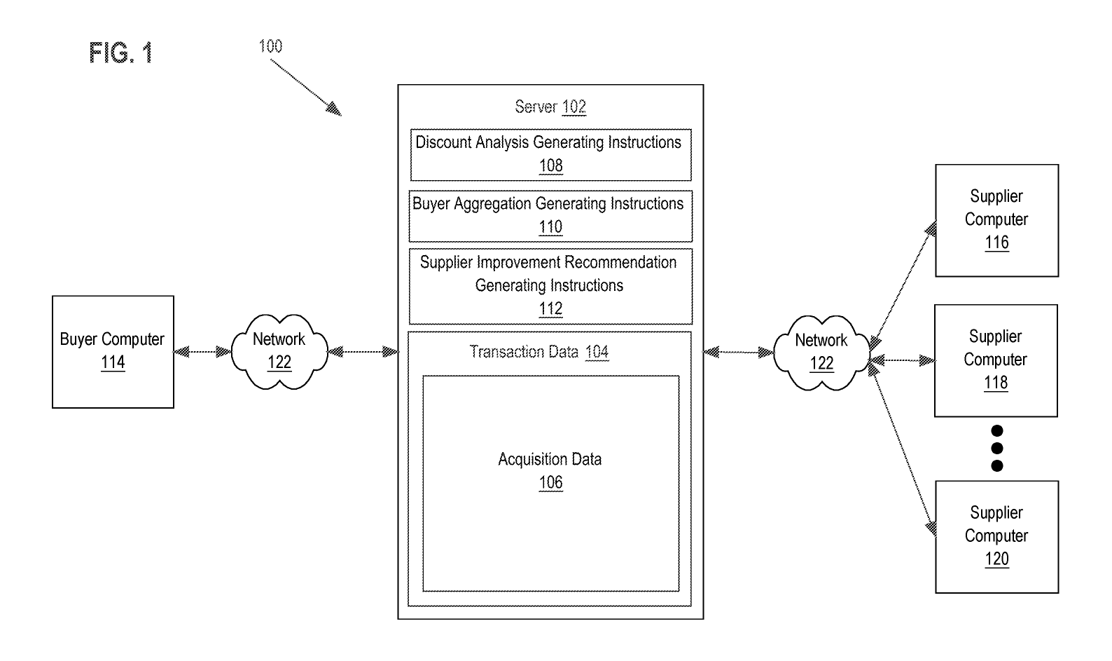

FIG. 1 depicts an example system in which the techniques described may be implemented according to an embodiment.

In the example of FIG. 1, a server computer 102, buyer computer 114, and supplier computers 116, 118, 120 are communicatively coupled to a data communications network 122. The network 122 broadly represents any combination of one or more data communication networks including local area networks, wide area networks, internetworks or internets, using any of wireline or wireless links, including terrestrial or satellite links. The network(s) may be implemented by any medium or mechanism that provides for the exchange of data between the various elements of FIG. 1. The various elements of FIG. 1 may also have direct (wired or wireless) communications links. The server computer 102, buyer computer 114, and supplier computers 116, 118, 120, and other elements of the system may each comprise an interface compatible with the network 160 and are programmed or configured to use standardized protocols for communication across the networks such as TCP/IP, Bluetooth, and higher-layer protocols such as HTTP, TLS, and the like.

Server computer 102 may be implemented using a server-class computer or other computers having one or more processor cores, co-processors, or other computers. Server computer 102 may be a physical server computer and/or a virtual server instance stored in a data center, such as through cloud computing. The server computer 102 may be programmed or configured to store transaction data and analyze the transaction data in order to generate recommendations. The server computer may comprise a plurality of communicatively coupled server computers including a server computer for storing past transaction data 104. The server computer 102 may additionally receive information that is not specific to individual transactions, such as public contact information of suppliers, website URLs for suppliers, and catalogue information for suppliers. The transactional data 104 may be used to generate recommendations, such as supplier improvement recommendations.

Transactional data 104 includes data regarding transactions through one or more software platforms. The transactional data 104 includes data regarding past transactions and data generated from the past transactions. The transaction data 104 may include any of a buyer identifier, a supplier identifier, a buyer generated tag, product information, pricing information, a billing code, location data, a rating for a supplier of the transaction, event data, and any other data associated with the transactions. While transactions are generally described in terms of supplying of goods, a transaction may additionally comprise the purchase of services and/or a combination of goods and services.

Past transactions may include transaction data between a plurality of buyers and a plurality of suppliers. The past transactions may include a supplier ID which identifies the supplier in the transaction, a buyer ID which identifies the supplier in the transaction an item ID which identifies at least one item purchased in the transaction, and additional transaction details. Additional transaction details may include additional data regarding the transaction, such as a tag for the transaction, a billing code for the purchaser, a number of items purchased, a price per unit of the items, identifiers of one or more other suppliers that bid against the supplier of the transaction, contact information for the supplier, and other transaction details.

In an embodiment, the server computer 102 may additionally store data separate from the transactions that are related to the transactions. For example, the server computer 102 may store supplier profiles that identify suppliers, contact information for the suppliers, win rate for the suppliers, past transactions of the suppliers, categorization data that categorizes items associated with transactions, discount threshold data, and any other data determined or generated by the Discount Analysis Generating Instructions 108, Buyer Aggregation Generating Instructions 110, and Supplier Improvement Recommendation Generating Instructions 112.

Acquisition data 106 includes data regarding buyer purchases from suppliers such as cost of items or commodities, quantity, and any subset of transaction data 104 related to buyer acquisitions of items or commodities.

The Discount Analysis Generating Instructions 108 may be programmed or configured to determine supplier economic data for one or more suppliers. For example, the Discount Analysis Generating Instructions 108 may include features to access information from the transaction data 104. The Discount Analysis Generating Instructions 108 may also transmit or receive data to and from the Buyer Aggregation Generating Instructions 110 and Supplier Improvement Recommendation Generating Instructions 112. The Discount Analysis Generating Instructions 108 may also be used for implementing aspects of the flow diagrams that are further described herein.

The Buyer Aggregation Generating Instructions 110 may be programmed or configured to aggregated recipient economic data. For example, the Buyer Aggregation Generating Instructions 110 may include features to access information from the transaction data 104. The Buyer Aggregation Generating Instructions 110 may also transmit or receive data to and from the Discount Analysis Generating Instructions 108 and Supplier Improvement Recommendation Generating Instructions 112. The Buyer Aggregation Generating Instructions 110 may also be used for implementing aspects of the flow diagrams that are further described herein.

The Supplier Improvement Recommendation Generating Instructions 112 may be programmed or configured to determine an improvement set of suppliers. For example, the Supplier Improvement Recommendation Generating Instructions 112 may include features to access information from the transaction data 104. The Supplier Improvement Recommendation Generating Instructions 112 may also transmit or receive data to and from the Discount Analysis Generating Instructions 108 and Buyer Aggregation Generating Instructions 110. The Supplier Improvement Recommendation Generating Instructions 112 may also be used for implementing aspects of the flow diagrams that are further described herein.

Computer executable instructions described herein may be in machine executable code in the instruction set of a CPU and may have been compiled based upon source code written in JAVA, C, C++, OBJECTIVE-C, or any other human-readable programming language or environment, alone or in combination with scripts in JAVASCRIPT, other scripting languages and other programming source text. In another embodiment, the programmed instructions also may represent one or more files or projects of source code that are digitally stored in a mass storage device such as non-volatile RAM or disk storage, in the systems of FIG. 1 or a separate repository system, which when compiled or interpreted cause generating executable instructions which when executed cause the computer to perform the functions or operations that are described herein with reference to those instructions. In other words, the drawing figure may represent the manner in which programmers or software developers organize and arrange source code for later compilation into an executable, or interpretation into bytecode or the equivalent, for execution by the server computer 102.

The computing devices such as the buyer computer 114 and supplier computers 116, 118, 120 may comprise a desktop computer, laptop computer, tablet computer, smartphone, or any other type of computing device that allows access to the server 102. The buyer computer 112 may be associated with one or more buyers. Each supplier computer 116, 118, 120 may be associated with one or more suppliers.

FIG. 1 depicts server computer 102 as a distinct element for the purpose of illustrating a clear example. However, in other embodiments, more or fewer server computers may accomplish the functions described herein. Additionally, server computer 102 may comprise a plurality of communicatively coupled server computers including a server computer for storing past transaction data.

3.0 Method Overview

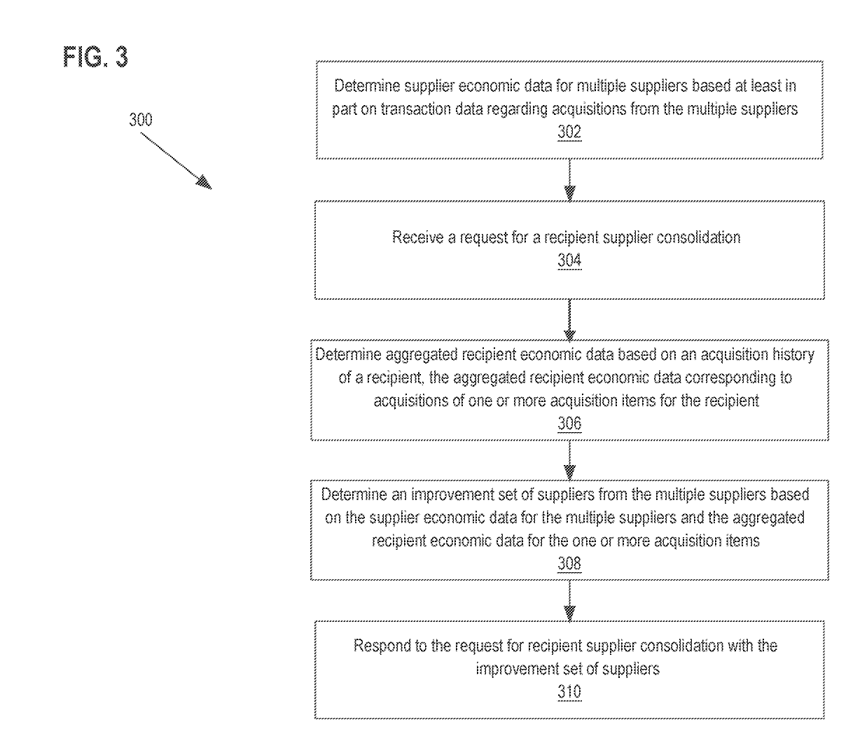

FIG. 3 is a flowchart of an example method of providing supplier insights with redress options, according to various embodiments.

For purposes of illustrating a clear example, FIG. 1 is described herein in the context of FIG. 1, but the broad principles of FIG. 3 can be applied to other systems having configurations other than as shown in FIG. 1. Further, FIG. 3 and each other flow diagram herein illustrates an algorithm or plan that may be used as a basis for programming one or more of the functional modules of FIG. 1 that relate to the functions that are illustrated in the diagram, using a programming development environment or programming language that is deemed suitable for the task. Thus, FIG. 3 and each other flow diagram herein are intended as an illustration at the functional level at which skilled persons, in the art to which this disclosure pertain s, communicate with one another to describe and implement algorithms using programming. The flow diagrams are not intended to illustrate every instruction, method object or sub step that would be needed to program every aspect of a working program, but are provided at the high, functional level of illustration that is normally used at the high level of skill in this art to communicate the basis of developing working programs.

In step 302, supplier economic data is determined for multiple suppliers based at least in part on transaction data regarding acquisitions from the multiple suppliers. For example, the server computer 102 may receive transaction data between a plurality of buyers and a plurality of suppliers and store the data relating to the transactions as transaction data 104 and acquisition data 106. The Discount Analysis Generating Instructions 108 may retrieve data regarding buyer acquisitions from the multiple suppliers from the transaction data 104 or acquisition data 106 and determine supplier economic data.

In an embodiment, transaction data may be categorized based on one or more items associated with acquisitions from multiple suppliers. For example, one buyer may refer to a transaction that includes the purchase of items such as pens and paper as ‘Office Supplies’, where another buyer may refer to the purchase of items such as pens and paper as ‘Office Supplies less than $10,000’, or ‘Office Supplies more than $10,000’. Another buyer may also refer to items or commodities in the transaction as simply ‘Pens and paper’. The Discount Analysis Generating Instructions 108 may identify that all of the items used in the above discussed example correspond to a specific spend category, such as the ‘Office Supplies’ spend category, and assign the ‘Office Supplies’ spend category to all transactions between a buyer and a supplier where the transaction data associated with the respective transaction satisfies the ‘Office Supplies’ categorization criteria. The Discount Analysis Generating Instructions 108 may store an identified spend category in association with the transaction data for a transaction between a buyer and supplier in the transaction data 104.

In an embodiment, the server computer trains a machine learning tool for categorizing transaction data. For example, training datasets may be generated based on prior transactions that were already identified as being associated with specific spend categories, such as through manual verification. The server computer may train the machine learning network using the training datasets which include transaction data and spend categories. The server computer may then use transactions that include items without identified spend categories as input into the machine learning model in order to identify spend categories from the transaction data.

In an embodiment, supplier discount thresholds may be determined based on the categorized transaction data and comparison of previous transactions between buyers and suppliers. For example, the Discount Analysis Generating Instructions 108 may form a database query that retrieves records from the transaction data 104 for all transactions that include an ‘Office Supplies’ spend categorization. The returned records may include data regarding all transactions between buyers and suppliers that have been categorized as ‘Office Supplies’.

Similarly, the Discount Analysis Generating Instructions 108 may further analyze the returned records from the query to determine supplier discount thresholds for one or more spend categories. For example, the Discount Analysis Generating Instructions 108 may specify a time frame (e.g. 12 months) where each transaction between a buyer and supplier in a specific spend category is analyzed to determine price level discounts. The Discount Analysis Generating Instructions 108 may determine that a first buyer spent more $1,000,000 total on items in the ‘Office Supplies’ category over multiple transactions with a particular supplier in the last 12 months. The Discount Analysis Generating Instructions 108 may also determine that a second buyer spent less than $1,000,000, but more than $500,000 total on items in the ‘Office Supplies’ category over multiple transactions with the particular supplier in the last 12 months. Lastly, the Discount Analysis Generating Instructions 108 may determine that a third buyer spent less than $500,000, total on items in the ‘Office Supplies’ spend category over multiple transactions with the particular supplier in the last 12 months.

By programmatically comparing the total spend of different buyers with respect to the same supplier and spend category over a period of time, supplier discount thresholds may be determined. For example, it may be determined based on the analysis that buyers that who spend more than $1,000,000 on items in the ‘Office Supplies’ category with a specific supplier get a 50% discount, buyers that spend less than $1,000,000 but more than $500,000 with the specific supplier get a 20% discount, and buyers that spend less than $500,000 but more than $200,000 with the specific supplier get a 5% discount.

Thus, the Discount Analysis Generating Instruction 108 may produce supplier economic data that indicates, for each supplier of multiple suppliers, discount thresholds for receiving discounts in one or more spend categories.

In step 304, a request is received for a recipient supplier consolidation. For example, the server computer 102 may receive a request from buyer computer 114 to consolidate the suppliers that a buyer associated with buyer computer 114 has transacted with. A recipient may be defined as a buyer that receives a commodity or item in a transaction with a supplier.

In step 306, aggregated recipient economic data is determined based on an acquisition history of a recipient, the aggregated recipient economic data corresponding to acquisitions of one or more acquisition items for the recipient. For example, the Buyer Aggregation Generating Instructions 110 may send a programmatic request to the server 102 to obtain acquisition data 106 regarding the acquisition history of a recipient. Acquisition history of a recipient may include all data associated with previous transactions between one or more buyers and suppliers. An acquisition item may be defined as any item or commodity received or acquired in a transaction.

In an embodiment, a buyer may be related to one or more buyers. For example, a buyer may have one or more subsidiaries that operate in different locations. Data indicating relationships between buyers may be stored in transaction data 104.

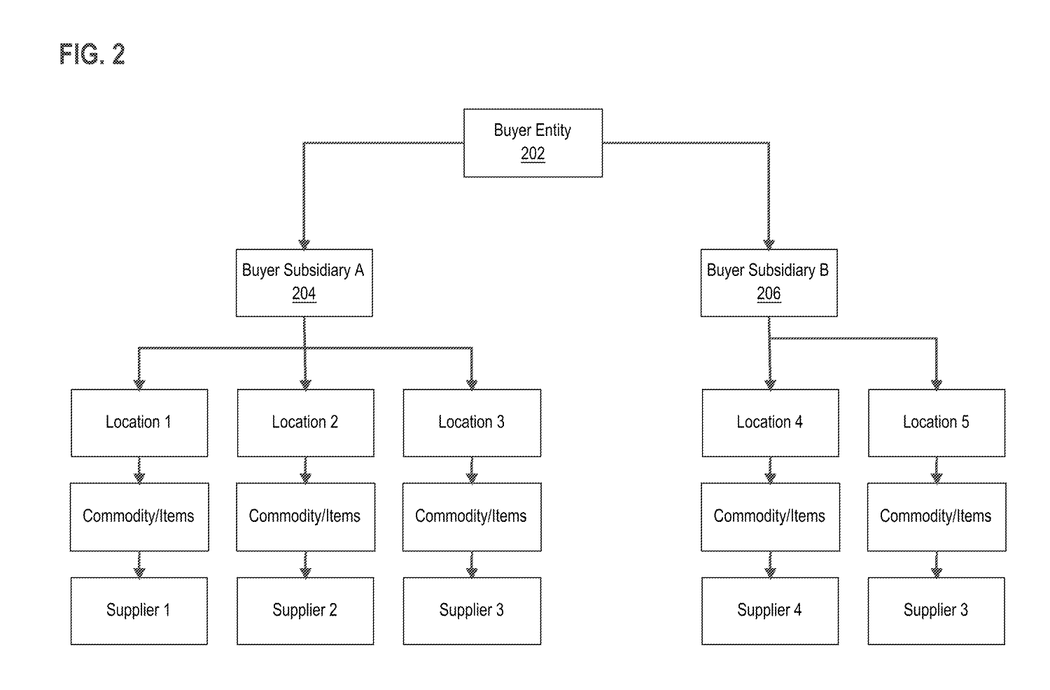

For example, as shown in FIG. 2, a single buyer entity 202 may have multiple subsidiaries such Buyer Subsidiary A 204 and Buyer Subsidiary B 206. Each buyer subsidiary 204, 206 may operate in different locations such as ‘Location 1′’, ‘Location 2’, and ‘Location 3’. Each Buyer Subsidiary 204, 206 may purchase commodities/items from a different supplier depending on the location of the respective subsidiary. For example, Buyer Subsidiary A 204 at ‘Location 1’ may purchase Office Supplies from ‘Supplier 1’, where Buyer Subsidiary A at location 2 may purchase Office Supplies from ‘Supplier 2’. Thus, different subsidiaries of the same buyer entity may engage in transactions for the same commodity or item with multiple suppliers across different locations.

In an embodiment, determining aggregated recipient economic data includes categorizing transactions included in the acquisition history of the recipient and aggregating the categorized transactions into aggregated recipient economic data.

The Buyer Aggregation Generating Instructions 110 may categorize transactions associated with a buyer, including transactions associated with buyers that are related to the buyer. As discussed above with respect to step 202, transaction data 104 may be categorized based on the items associated with a transaction. For example, Buyer Subsidiary A 204 at ‘Location 1’ may refer to a transaction that includes the purchase of items such as pens and paper as ‘Office Supplies’, where Buyer Subsidiary B 206 at ‘Location 4’ may refer to the purchase of items such as pens and paper as ‘Office Supplies less than $10,000’, or ‘Office Supplies more than $10,000’. The Buyer Aggregation Generating Instructions 110 may identify that the items in the above example all correspond to a specific spend category, such as the ‘Office Supplies’ category, and assign the ‘Office Supplies’ spend category to all transactions between a buyer and supplier where the transaction data associated with the respective transaction satisfies the ‘Office Supplies’ categorization criteria.

Any suitable categorization technique, such as those discussed with respect to step 202, may be used to categorize the transactions between a buyer and supplier.

In an embodiment, once the transactions are categorized, for each spend category, spend associated with transactions by the buyer is aggregated with spend associated with transactions by buyers that are related to the buyer. For example, from FIG. 2, Buyer Subsidiary A 204 may have engaged in several transactions with different suppliers for items in the ‘Office Supplies’ category within the last 12 months totaling $900,000. Buyer Subsidiary B 206 may have engaged in several transactions with different suppliers for items in the ‘Office Supplies’ category within the last 12 months totaling $150,000. When aggregated, the total spend for the buyer and related buyers in the ‘Office Supplies’ spend category over the last 12 months totals $1,050,000.

Thus, aggregated recipient economic data may indicate the total spend for a buyer and one or more related buyers over a time period for one or more spend categories.

In step 308, an improvement set of suppliers is determined from the multiple suppliers based on the supplier economic data for the multiple suppliers and the aggregated recipient economic data for the one or more acquisition items. An improvement set of suppliers may include one or more suppliers. For example, the Supplier Improvement Recommendation Generating Instructions 112 may receive the aggregated recipient economic data from the Buyer Aggregation Generating Instructions 110 and the supplier economic data from the Discount Analysis Generating Instructions 108 to generate an improvement set of suppliers from the multiple suppliers.

As discussed in step 302, supplier economic data may indicate, for each supplier of multiple suppliers, discount thresholds for receiving discounts in one or more spend categories. As discussed in step 306, aggregated recipient economic data may indicate the total spend for a buyer and one or more related buyers over a time period for one or more spend categories. The Supplier Improvement Recommendation Generating Instructions 112 may programmatically compare the supplier economic data to the aggregated recipient economic data to determine an improvement set of suppliers that the recipient could potentially transact with for spend categories where the recipient would be eligible for discounts.

For example, the supplier economic data may indicate that buyers that who spend more than $1,000,000 on items in the ‘Office Supplies’ category with a specific supplier get a 50% discount, buyers that spend less than $1,000,000 with the specific supplier get a 20% discount, and buyers that spend less than $500,000 with the specific supplier get a 5% discount. The aggregated recipient economic data may indicate that the total spend of a buyer and one or more related buyers for the ‘Office Supplies’ category over the last 12 months totals $1,050,000. Based on comparing the total spend of $1,050,000 to the discount thresholds from the supplier economic data, it may be determined that the specific supplier may offer the benefit of a 50% discount to a buyer because the total spend of the buyer and one or more related buyers for the ‘Office Supplies’ spend category satisfies the discount threshold for the specific supplier. Upon making this determination, the specific supplier may be added to the improvement set of suppliers.

In an embodiment, the improvement set of suppliers indicates one or more suppliers that are capable of providing a spend discount to a buyer. For example, the improvement set of suppliers may provide a set of one or more suppliers that have discount thresholds where, if a buyer and related buyers were to consolidate the total spend for a spend category to a single supplier, the total spend of a buyer and related buyers will satisfy the discount threshold criteria of a supplier and thus would be eligible to receive a discount from the supplier.

In an embodiment, determining the improvement set of suppliers based on the aggregated recipient economic data and the supplier economic data includes determining the improvement set of suppliers based on delivery locations of the suppliers, community ratings of the suppliers, and health score of the suppliers.

For example, transaction data associated with a supplier may be analyzed to determine one or more delivery locations where the supplier can fulfill orders. The one or more delivery locations may be determined based on identifying locations or geographic areas from previous transactions associated with the supplier where the supplier has successfully fulfilled an order. Additionally, locations where a supplier can deliver may be provided by the supplier. The delivery locations of a supplier may be used to filter suppliers from the improvement set of suppliers that may not be able to deliver to the locations where a buyer and associated buyer subsidiaries are located. One or more of the delivery locations of the suppliers, community ratings of the suppliers, and health score of the suppliers, alone or in combination, may be used to determine the improvement set of suppliers.

Community ratings and health score values, which are described in U.S. patent application Ser. No. 15/683,689, filed Aug. 22, 2017, the entire contents of which are incorporated by reference as if fully disclosed herein, may also be utilized to filter suppliers from the improvement set of suppliers. For example, if it is determined that a supplier has a health score or community rating below a threshold value, the supplier may not be included in the improvement set of suppliers.

In an embodiment, in response to determining that a total spend for a spend category of a recipient and related recipients is within a threshold amount of a discount threshold, generating and causing displaying, at a computer associated with recipient, a notification indicating that the total spend for a spend category is within a threshold amount of a supplier discount threshold.

For example, if the total spend of a buyer and one or more related buyers in the ‘Office Supplies’ category is $950,000 and it is determined that a supplier has a discount threshold of $1,000,000 on items in the ‘Office Supplies’ category with a 50% discount, the buyer and one or more related buyers may not qualify for the discount because the total spend does not meet the $1,000,000 discount threshold. However, because the total spend is within $100,000 of the discount threshold amount, the buyer may receive a notification indicating that the total spend for the ‘Office Supplies’ spend category is within a threshold amount of a supplier discount threshold. Using this information, a buyer may determine that spending an extra $50,000 on items in the ‘Office Supplies’ category could ultimately be cost effective due to the increased discount offered at the $1,000,000 discount threshold.

In an embodiment, it is determined that a threshold amount of acquisitions by a buyer fall within a certain spend category. For example, it may be determined that out of 100 acquisitions by a buyer, 70 (e.g. 70%) of the acquisitions are associated with the ‘Office Supplies’ category. In response to determining that a threshold amount of acquisitions by a buyer fall within a certain spend category, the spend category is identified as a critical spend category. A critical spend category identifies a category of spend that could potentially be disruptive to business operations.

For example, if a buyer consolidated all spend across multiple related buyers in order to take advantage of a discount offered by a supplier and the supplier suddenly went out of business, the buyer would need to find an immediate replacement supplier in order to prevent disruptions in business operations. To safeguard against this type of risk, critical spend categories may be identified as discussed above.

In an embodiment, a minimum number of suppliers in the improvement set is determined based on identifying a critical spend category. For example, if the ‘Office Supplies’ spend category is identified as critical, instead of providing an improvement set of suppliers with 1 supplier, the improvement set of suppliers may include, at minimum, 3 suppliers so that a buyer may be afforded the opportunity to distribute the risk of business operation disruption across multiple suppliers.

In step 304, the received request for recipient supplier consolidation is responded to with the improvement set of suppliers. For example, the server computer may respond to the request from a buyer computer to consolidate the suppliers with the improvement set of suppliers.

Using the improvement set of suppliers, a buyer may consolidate the purchases of the buyer and related buyers to one or more suppliers that may offer discounted prices for the total spend of the buyer and related buyers.

Implementation Example—Hardware Overview

According to some embodiments, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

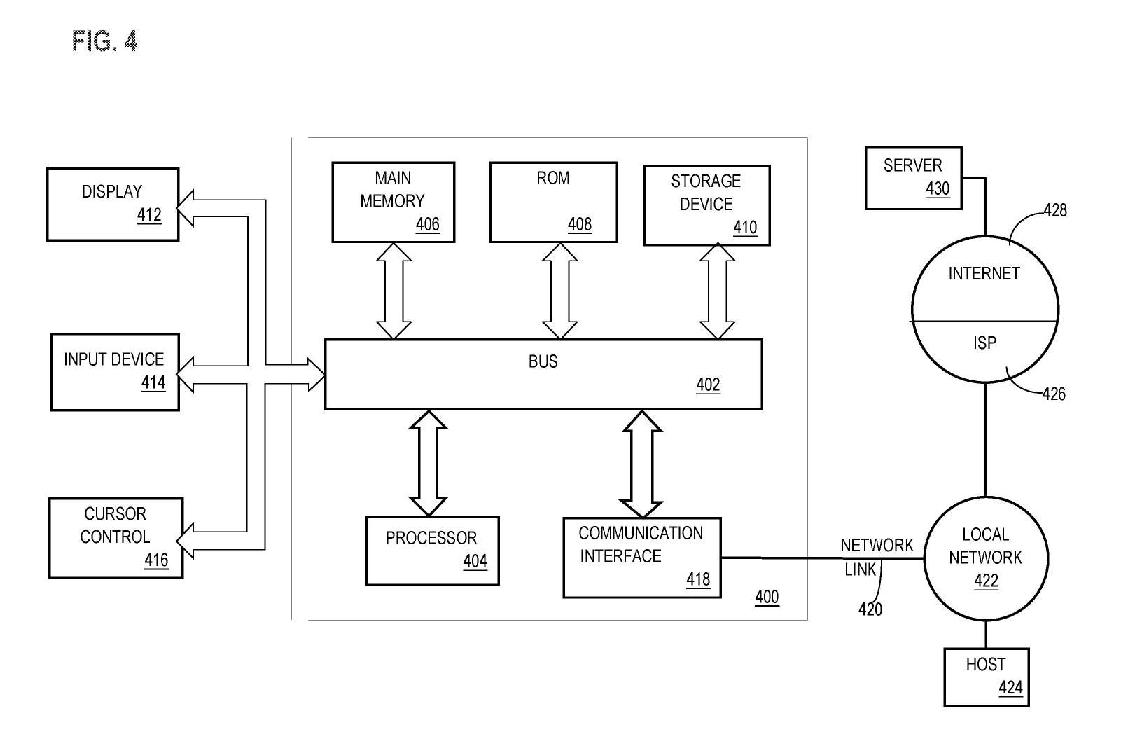

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as an OLED, LED or cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane. The input device 414 may also have multiple input modalities, such as multiple 2-axes controllers, and/or input buttons or keyboard. This allows a user to input along more than two dimensions simultaneously and/or control the input of more than one type of action.

Computer system 400 may implement the techniques described herein using customized hard-wired logic, one or more ASICs or FPGAs, firmware and/or program logic which in combination with the computer system causes or programs computer system 400 to be a special-purpose machine. According to some embodiments, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information. Such a wireless link could be a Bluetooth, Bluetooth Low Energy (BLE), 802.11 WiFi connection, or the like.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

5.0 Other Aspects of Disclosure

Although some of the figures described in the foregoing specification include flow diagrams with steps that are shown in an order, the steps may be performed in any order, and are not limited to the order shown in those flowcharts. Additionally, some steps may be optional, may be performed multiple times, and/or may be performed by different components. All steps, operations and functions of a flow diagram that are described herein are intended to indicate operations that are performed using programming in a special-purpose computer or general-purpose computer, in various embodiments. In other words, each flow diagram in this disclosure, in combination with the related text herein, is a guide, plan or specification of all or part of an algorithm for programming a computer to execute the functions that are described. The level of skill in the field associated with this disclosure is known to be high, and therefore the flow diagrams and related text in this disclosure have been prepared to convey information at a level of sufficiency and detail that is normally expected in the field when skilled persons communicate among themselves with respect to programs, algorithms and their implementation.

In the foregoing specification, the example embodiment(s) of the present invention have been described with reference to numerous specific details. However, the details may vary from implementation to implementation according to the requirements of the particular implement at hand. The example embodiment(s) are, accordingly, to be regarded in an illustrative rather than a restrictive sense.

What is claimed is:

1. A data processing method executed using an e-procurement computer system and comprising the computer-implemented steps of:
determining supplier economic data for multiple different suppliers of goods or services, based at least in part on data describing prior transactions for acquisitions from the multiple suppliers;
receiving a digital electronic message comprising a request for a supplier consolidation in association with a recipient;
determining aggregated recipient economic data based on an acquisition history of the recipient involving a plurality of transactions, the aggregated recipient economic data corresponding to a plurality of acquisitions of one or more acquisition items for the recipient;
determining an improvement set of suppliers from the multiple suppliers based on the supplier economic data for the multiple suppliers and the aggregated recipient economic data for the one or more acquisition items;
responding to the request by electronically transmitting the improvement set of suppliers;
wherein the method is performed using one or more computing devices.

2. The method of claim 1, wherein determining supplier economic data includes:
categorizing transaction data based on one or more items associated with past acquisitions of goods or services from the multiple suppliers;
determining supplier discount thresholds based on the categorized transaction data and comparison of previous transactions between recipients and suppliers.

3. The method of claim 1, wherein the supplier economic data comprises supplier discount threshold values associated with different discounts that are available in one or more spend categories.

4. The method of claim 1, wherein the aggregated recipient economic data indicates total spend for the recipient and one or more related recipients, over a period, for a plurality of different spend categories.

5. The method of claim 1, wherein determining aggregated recipient economic data includes categorizing transactions included in the acquisition history of the recipient and aggregating the categorized transactions into aggregated recipient economic data.

6. The method of claim 5, wherein categorizing transactions included in the acquisition history of the recipient includes categorizing transactions associated with the recipient and categorizing transactions associated with recipients that are related to the recipient.

7. The method of claim 5, wherein aggregating the categorized transactions into aggregated recipient economic data includes aggregating spend associated with transactions by the recipient and spend associated with transactions by recipients that are related to the recipient.

8. The method of claim 1, wherein the improvement set of suppliers indicates one or more suppliers that are capable of providing a spend discount to a recipient.

9. The method of claim 1, wherein determining the improvement set of suppliers includes determining the improvement set of suppliers based on delivery locations of the suppliers, community ratings of the suppliers, and health scores of the suppliers.

10. The method of claim 1, further comprising:
in response to determining that a total spend for a spend category of a recipient and related recipients is within a threshold amount of a discount threshold, generating and causing displaying, at a computer associated with the recipient, a notification indicating that the total spend for a spend category is within a threshold amount of a supplier discount threshold.

11. The method of claim 1, further comprising:
in response to determining that a threshold amount of acquisitions by a buyer fall within a spend category, identifying the spend category as a critical spend category;
determining a minimum number of suppliers in the improvement set based on identifying a critical spend category.

12. A data processing method comprising:
determining supplier economic data for multiple suppliers, including:
categorizing transaction data based on one or more items associated with acquisitions from multiple suppliers;
determining supplier discount thresholds based on the categorized transaction data and comparison of previous transactions between recipients and suppliers;
receiving a request for a recipient supplier consolidation;
determining aggregated recipient economic data based on an acquisition history of the recipient, including:
categorizing transactions included in the acquisition history of the recipient and aggregating the categorized transactions into aggregated recipient economic data, including categorizing transactions associated with the recipient, categorizing transactions associated with recipients that are related to the recipient, and aggregating spend associated with transactions by the recipient and spend associated with transactions by the recipients that are related to the recipient;
determining an improvement set of suppliers from the multiple suppliers based on the supplier economic data for the multiple suppliers, the aggregated recipient economic data for the one or more acquisition items, delivery locations of the multiple suppliers, community ratings of the multiple suppliers, and health scores of the multiple suppliers;
wherein the improvement set of suppliers indicates one or more suppliers that are capable of providing a spend discount to a recipient;
responding to the received request for recipient supplier consolidation with the improvement set of suppliers;
wherein the method is performed using one or more computing devices.

13. A data processing system comprising:
one or more hardware processors;
a non-transitory computer-readable medium having instructions embodied thereon, the instructions, when executed by the one or more processors, cause:
determining supplier economic data for multiple different suppliers of goods or services, based at least in part on data describing prior transactions for acquisitions from the multiple suppliers;
receiving a digital electronic message comprising a request for a supplier consolidation in association with a recipient;
determining aggregated recipient economic data based on an acquisition history of the recipient involving a plurality of transactions, the aggregated recipient economic data corresponding to a plurality of acquisitions of one or more acquisition items for the recipient;
determining an improvement set of suppliers from the multiple suppliers based on the supplier economic data for the multiple suppliers and the aggregated recipient economic data for the one or more acquisition items;
responding to the request by electronically transmitting the improvement set of suppliers;

14. The system of claim 13, wherein determining supplier economic data includes:
categorizing transaction data based on one or more items associated with past acquisitions of goods or services from the multiple suppliers;
determining supplier discount thresholds based on the categorized transaction data and comparison of previous transactions between recipients and suppliers.

15. The system of claim 13, wherein the supplier economic data comprises supplier discount threshold values associated with different discounts that are available in one or more spend categories.

16. The system of claim 13, wherein the aggregated recipient economic data indicates total spend for the recipient and one or more related recipients, over a period, for a plurality of different spend categories.

17. The system of claim 13, wherein determining aggregated recipient economic data includes categorizing transactions included in the acquisition history of the recipient and aggregating the categorized transactions into aggregated recipient economic data.

18. The system of claim 17, wherein categorizing transactions included in the acquisition history of the recipient includes categorizing transactions associated with the recipient and categorizing transactions associated with recipients that are related to the recipient.

19. The system of claim 17, wherein aggregating the categorized transactions into aggregated recipient economic data includes aggregating spend associated with transactions by the recipient and spend associated with transactions by recipients that are related to the recipient.

20. The system of claim 1, wherein the improvement set of suppliers indicates one or more suppliers that are capable of providing a spend discount to a recipient.

21. The system of claim 1, wherein determining the improvement set of suppliers includes determining the improvement set of suppliers based on delivery locations of the suppliers, community ratings of the suppliers, and health scores of the suppliers.

22. The system of claim 1, further comprising:
in response to determining that a total spend for a spend category of a recipient and related recipients is within a threshold amount of a discount threshold, generating and causing displaying, at a computer associated with the recipient, a notification indicating that the total spend for a spend category is within a threshold amount of a supplier discount threshold.

23. The system of claim 1, further comprising:
in response to determining that a threshold amount of acquisitions by a buyer fall within a spend category, identifying the spend category as a critical spend category;
determining a minimum number of suppliers in the improvement set based on identifying a critical spend category.
